(19) United States
(12) Patent Application Publication
(10) Pub. No.: US 2017/0318138 A1
(43) Pub. Date: Nov. 2, 2017

(54) MULTIPURPOSE STATIONERY TOOL

(71) Applicant: REXON INDUSTRIAL CORP., LTD., Taichung (TW)

(72) Inventors: Chih-Cheng LAI, Taichung (TW); Ya-Pin KUO, Taichung (TW)

(21) Appl. No.: 15/584,280

(22) Filed: May 2, 2017

(30) Foreign Application Priority Data
May 2, 2016 (TW) 105113630

(51) Int. Cl. H04M 1/04

(52) U.S. Cl. CPC H04M 1/04; A45C 2011/002

(57) ABSTRACT

A multipurpose stationery tool includes a base including a pair of holders, a pair of first position-limiting portions and a pair of second position-limiting portions, a supporting unit including a pair of pivoting portions respectively pivotally connected to the pivot holders and a pair of swinging portions opposite to the pivoting portions and being adjustable in position relative to the base between an extended position where the supporting unit is stopped in place by the first position-limiting portions and a received position where the supporting unit is stopped in place by the second position-limiting portion, and an upper holder block adjustable in position relative to the supporting unit and including a holder block base pivotally connected to the swinging portions, a pair of extension rods bilaterally extended from the holder block base and two stop portions for stopping against the swinging portions in the extended position. Subject to the pivotable relationship between the base, the supporting unit and the upper holder block, the multipurpose stationery tool is practical for multipurpose applications.

### BACKGROUND OF THE INVENTION

### 1. Field of the Invention

The present invention relates to stationery or electronic product holder devices and more particularly, to a multipurpose stationery tool for holding a stationery or mobile electronic product.

### 2. Description of the Related Art

In recent years, due to the flourishing of cultural industry, electronic products, stationery and other related product designs have the concept of cultural design incorporated therein.

Among stationery products, commercial convenience stickers are provided in stacks for convenient use. However, a stack of convenience stickers can easily be lost or misplaced, such as covered on a desk by documents or paper, and substantial time may be lost to the sometimes futile task of searching for the stack. Taiwan Patent M422474 discloses a clip that provides a clamping function convenient for securing a stack of convenience stickers in place.

Further, Taiwan Patent Numbers D170174 and D164145 disclose different design of mobile phone holders for holding a mobile phone or tablet computer. These mobile phone holders occupy a certain dimensional space. When these mobile phone holders are not used for holding a mobile phone or tablet computer, however, they cannot be used for other purposes.

Therefore, how to effectively integrate a stationery carrier and a mobile electronic product carrier into a multipurpose carrier design has been an important issue cultural entrepreneurs need to study.

### SUMMARY OF THE INVENTION

The present invention has been accomplished under the circumstances in view. It is the main object of the present invention to provide a multipurpose stationery tool, which integrates stationery and mobile electronic device carriers into one design for multipurpose applications.

To achieve this and other objects of the present invention, a multipurpose stationery tool comprises a base, a supporting unit and an upper holder block. The base extends in a longitudinal direction, comprising a first end, a pair of pivot holders mounted at the first end and spaced in a transverse direction perpendicular to the longitudinal direction, a pair of first position-limiting portions respectively disposed in the pivot holders at one side, a pair of second position-limiting portions respectively disposed in the pivot holders at an other side, and a second end extended in the longitudinal direction opposite to the first end. The supporting unit is adjustable in position relative to the base, and comprises a pair of pivoting portions respectively pivotally connected to the pivot holders and a pair of swinging portions opposite to said pivoting portions. The supporting unit is adjustable relative to the base between an extended position where the supporting unit is stopped in place relative to the base by the first position-limiting portions, and a received position where the supporting unit is stopped in place relative to the base by the second position-limiting portions. The upper holder block is adjustable in position relative to the supporting unit, and comprises a holder block base, a pair of extension rods bilaterally extended from one side of the holder block base, two pivotal couplings located at a bottom side of the holder block base and spaced in the transverse direction and respectively pivotally connected to the swinging portions of the supporting unit, and two stop portions respectively located at the pivotal couplings at one side and adapted for stopping against the swinging portions in the extended position.

Subject to the design that the supporting unit is adjustable in position relative to the base and the upper holder block is adjustable in position relative to the supporting unit, the multipurpose stationery tool can be can be used for multipurpose application. Further, the overall configuration of the multipurpose stationery tool presents a treadmill model, providing added value.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a multipurpose stationery tool in accordance with the present invention.

FIG. 2 is an exploded view of the multipurpose stationery tool in accordance with the present invention.

FIG. 3 is a front plain view of the present invention, illustrating the supporting unit and the upper holder block disposed in the extended position relative to the base.

FIG. 4 is a schematic plain view of the present invention, illustrating the supporting unit and the upper holder block set in the received position relative to the base.

FIG. 5 is an oblique top elevational view of FIG. 4.

FIG. 6 is an applied view of the present invention, illustrating the multipurpose stationery tool used as a mobile electronic device carrier.

FIG. 7 is a sectional view taken along line VII-VII of FIG. 3.

### DETAILED DESCRIPTION OF THE INVENTION

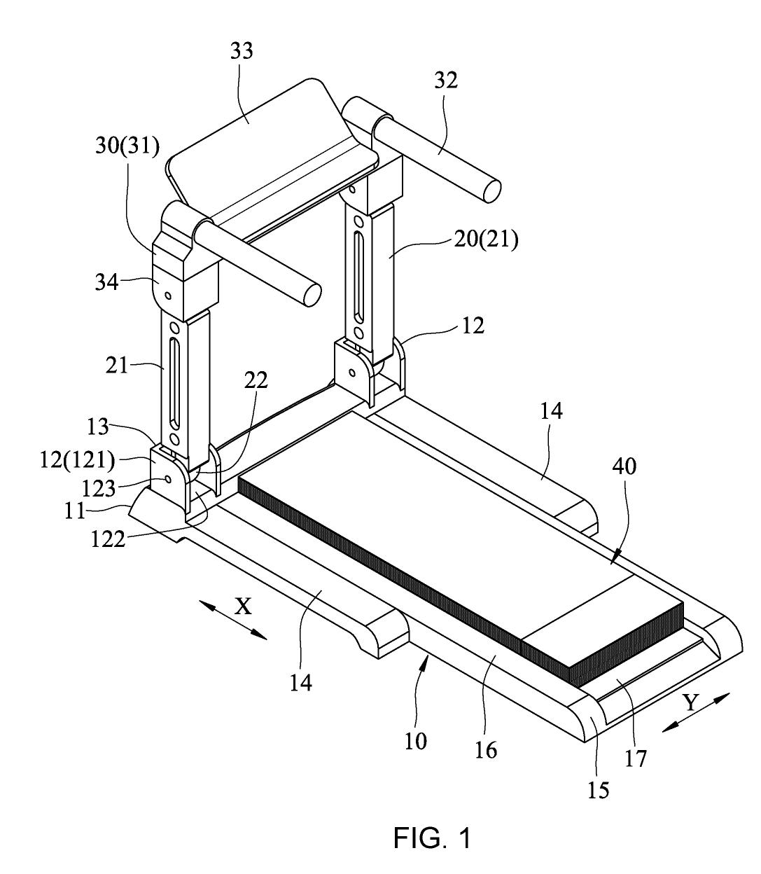

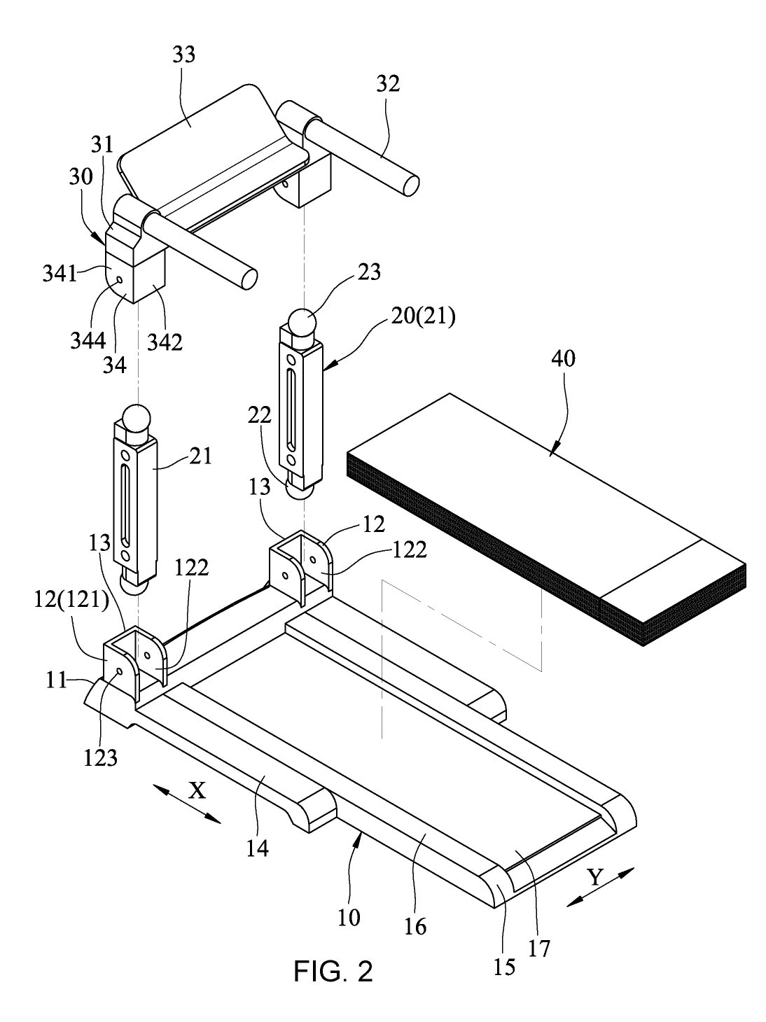

Referring to FIG. 1 and FIG. 2, a multipurpose stationery tool in accordance with the present invention is shown. The multipurpose stationery tool comprises a base 10, a supporting unit 20 and an upper holder block 30, and is adapted for holding an article such as, for example, a pack of convenience stickers 40.

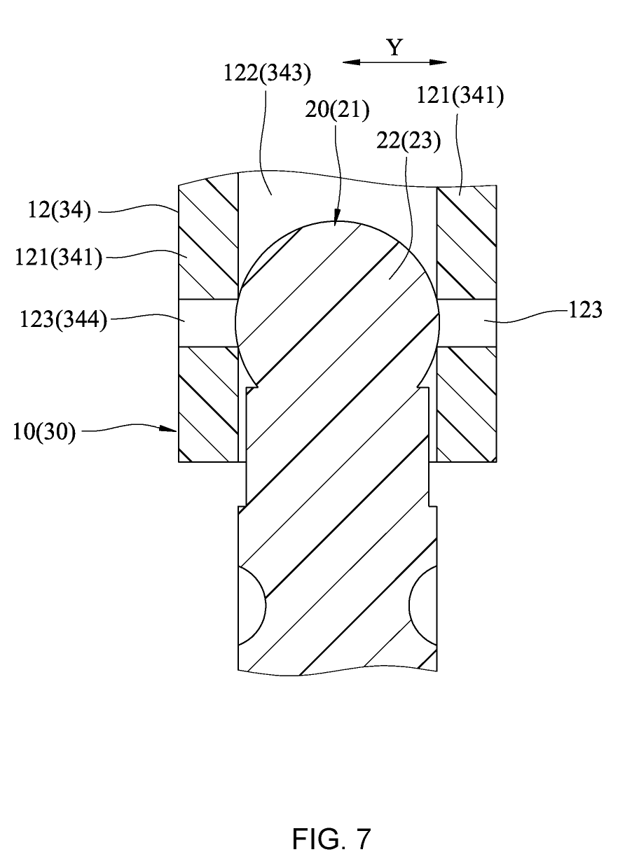

The base 10 is a plate member extending in a longitudinal direction X, comprising a first end 11, a pair of pivot holders 12 mounted at the first end 11 and spaced in a transverse direction Y perpendicular to the longitudinal direction X, a pair of first position-limiting portions 13 respectively disposed in the pivot holders 12 at one side, a pair of second position-limiting portions 14 respectively disposed in the pivot holders 12 at an other side, a second end 15 extended in the longitudinal direction X opposite to the first end 11, a top wall 16 extended from the first end 11 to the second end 15, and a recessed accommodation chamber 17 defined in the top wall 16 and extended from the second end 15 toward the first end 11. Referring also to FIG. 7, each pivot holder 12 comprises two upright pivot support plates 121 spaced in the transverse direction Y, a pivoting space 122 defined between the two upright pivot support plates 121, and a pivot hole 123 located in each upright pivot support plate 121. The first position-limiting portions 13 are plate-shaped components protruded from the top wall 16. Further, these first position-limiting portions 13 are respectively abutted to the pivoting spaces 122 in the pivot holders 12 and respectively connected with the upright pivot support plates 121 of the pivot holders 12 to exhibit an inverted-U shape. The second position-limiting portions 14 are respectively located at two opposite lateral sides of the top wall 16 and substantially disposed in parallel to the top wall 16. The pivoting spaces 122 are adapted for securing the supporting unit 20 in a pivotable manner to hold down the pack of convenience stickers 40.

The supporting unit 20 is adjustable in position relative to the base 10, comprising a pair of support bars 21 each having a pivoting portion 22 located at one end thereof and pivotally connected to one respective pivot holder and a swinging portion 23 located at an opposite end thereof. Referring also to FIG. 7, the pivoting portions 22 of the supporting unit 20 are spherical shaped members respectively pivotally accommodated in the pivoting spaces 122, having two opposite lateral sides of the periphery thereof protruding in the respective pivot holes 123 so that the pivoting portions 22 are rotatable in all directions relative to the respective pivot holders 12. The swinging portions 23 of the supporting unit 20 are spherical shaped members (the swinging portions 23 and the pivoting portions 22 substantially have the same shape; in order to simplify the drawings, the structures at both ends of the support bar 21 are combined together and shown in FIG. 7).

The upper holder block 30 is adjustable in position relative to the supporting unit 20, comprising a holder block base 31, a pair of extension rods 32 bilaterally extended from one side of the holder block base 31, a positioning plate 33 extended from an opposite side of the holder block base 31, two pivotal couplings 34 located at a bottom side of the holder block base 31 and spaced in the transverse direction Y and respectively pivotally connected to the swinging portions 23 of the supporting unit 20, and two stop portions 342 respectively located at the pivotal couplings 34 at one side (the shape and structure of the pivotal couplings 34 are substantially same as the pivot holders 12; in order to simplify the drawings, the structure of the pivotal couplings 34 is combined into FIG. 7). The pivotal couplings 34 each comprise two side panels 341 spaced in the transverse direction Y and a pivoting space 343 defined between the two side panels 341. The stop portions 342 are plate shaped members protruded from the holder block base 31. Further, the stop portions 342 are respectively disposed abutted to the respective pivoting spaces 343 at one side, and respectively connected with the respective side panels 341. The side panels 341 each have a through hole 344. The swinging portions 23 have two opposite lateral sides of the periphery thereof protruding in the respective through holes 3444 so that the swinging portions 23 are rotatable in all directions relative to the respective pivotal couplings 34.

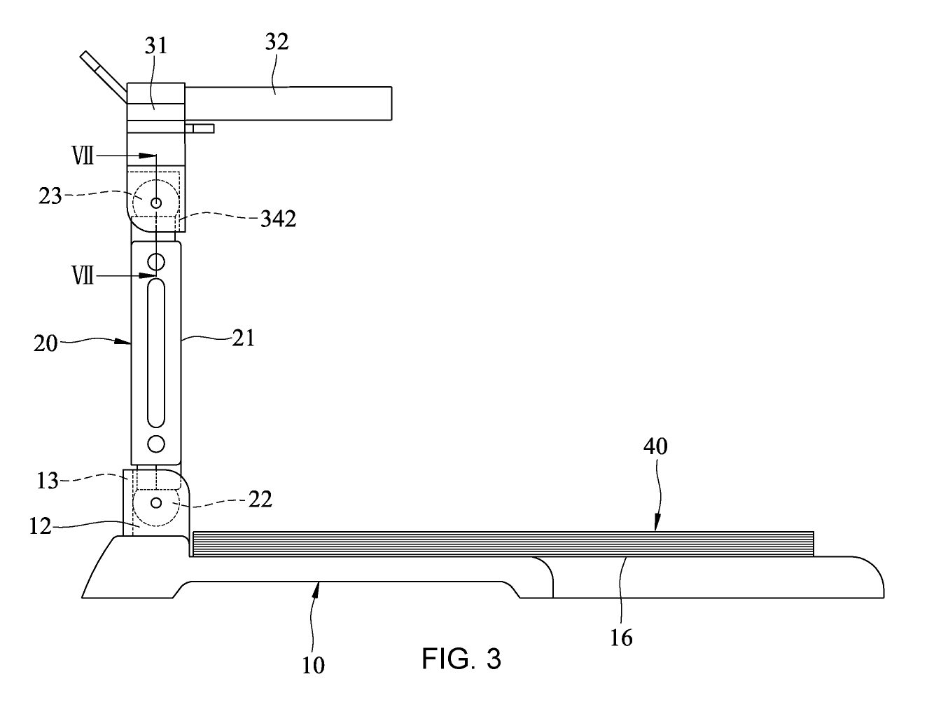

As illustrated in FIG. 1 and FIG. 3, when the supporting unit 20 is moved relative to the base 10 to a extended position, the first position-limiting portions 13 stop the pivoting portions 22 in position, supporting the support bars 21 in vertical relative to the top wall 16 and prohibiting the support bars 21 from moving relative to the pivot holders 12 in a counter-clockwise direction in FIG. 3. When the supporting unit 20 stands in the extended position, the stop portions 342 of the upper holder block 30 provide a position-limiting effect to the swinging portions 23, holding the extension rods 32 in substantially parallel relationship with the top wall 16 and prohibiting the holder block base 32 from moving relative to the support bars 21 in the clockwise direction in FIG. 3.

When in the extended position shown in FIGS. 1 and 3, the multipurpose stationery tool presents a treadmill model in its appearance, increasing the fun of the use of the multipurpose stationery tool and allowing the user to take one convenience sticker from the pack of convenience stickers 40 in the recessed chamber 17. Thus, the multipurpose stationery tool can secure the pack of convenience stickers 40 positively in place, making the pack of convenience stickers 40 not be easily concealed or lost.

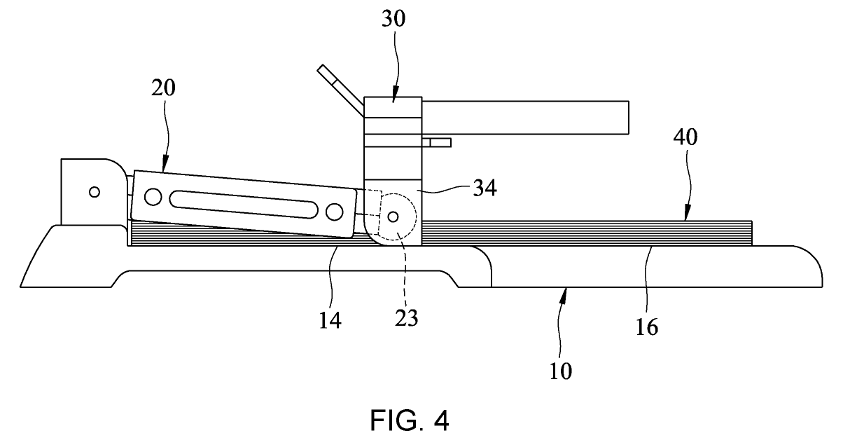

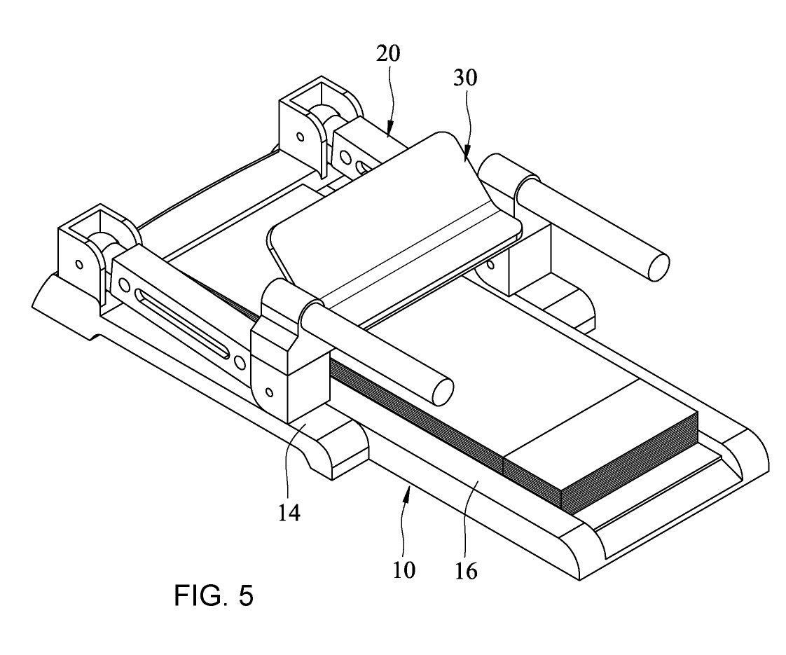

Referring to FIG. 4 and FIG. 5, when the user moves the supporting unit 20 relative to the base 10 from the extended position to a received position, the upper holder block 30 is positioned to about a 90-degree angle relative to the supporting unit 30 so that the swinging portions 23 and the upper holder block 30 are disposed in proximity to the top wall 16. At this time, the pivotal couplings 34 are abutted against the second position-limiting portions 14, keeping the supporting unit 20 and the upper holder block 30 constantly in the received position. In this received position, the dimension of the multipurpose stationery tool is minimized, facilitating packaging and carrying.

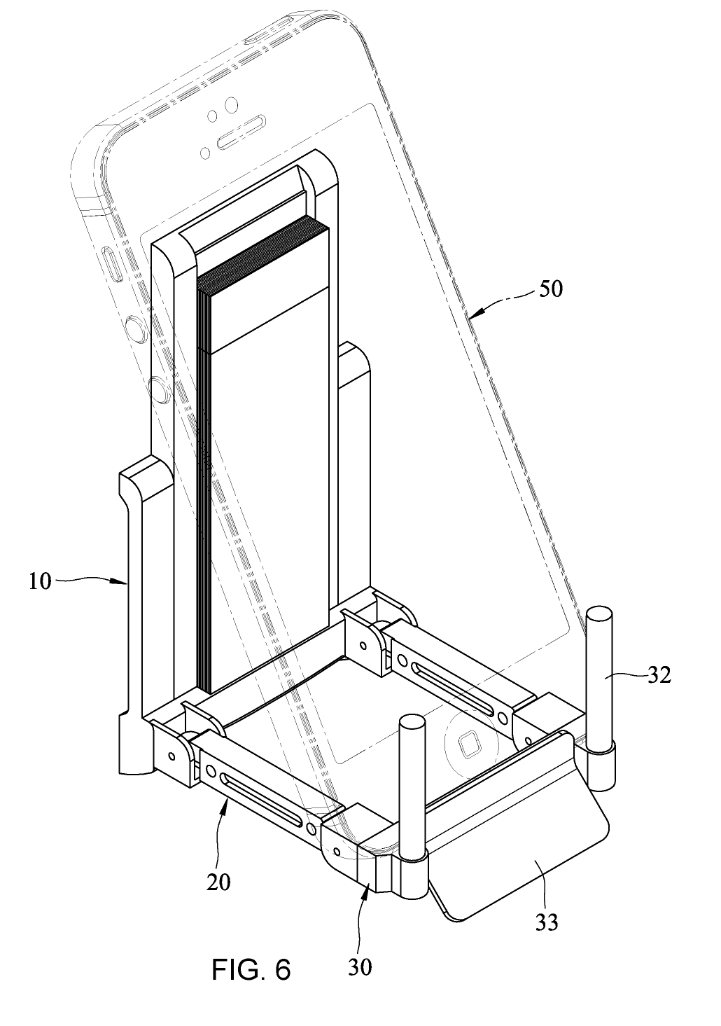

Referring to FIG. 6, when the multipurpose stationery tool is in the extended position, the multipurpose stationery tool can be turned through 90-degree angle placed with the supporting unit 20 on a tabletop to keep the base 10 in a vertical position relative to the tabletop. At this time, the base 10 is used as a back support to support a mobile electronic device 50 (such as mobile phone or tablet computer), the extension rods 32 of the upper holder block 30 are used as stop members to stop one end of the mobile electronic device 50 in place, and the positioning plate 33 is used as a positioning member to abut against the tabletop, enhancing positioning stability.

Thus, subject to the pivotable arrangement of the base 10, the support unit 20 and the upper holder block 30, the multipurpose stationery tool of the present invention utilizes can be conveniently set between the extended position for holding a pack of convenience stickers 40 or a mobile electronic device 50 and the received position for packaging or carrying. Further, when the multipurpose stationery tool is set in the extended position, it presents a treadmill model to provide added value.

Further, as illustrated in FIG. 7, subject to the design that the pivoting portions 22 and the swinging portions 23 are spherical, the pivot holes 123 of the upright support plates 121 are configured to support the respective pivoting portions 22 in a pivotable manner, and the through holes 344 of the side panels 341 are configured to support the respective swinging portions 23 in a pivotable manner in all directions, there are non-directional mounting restrictions when assembling the multipurpose stationery tool. Further, mounting and dismounting the multipurpose stationery tool can easily be achieved by plugging the pivoting portions 22 and the swinging portions 23 into the respective pivoting spaces 122 or 343, or pulling the pivoting portions 22 and the swinging portions 23 out of the respective pivoting spaces 122 or 343, i.e., the mounting and dismounting of the pivoting portions 22 relative to the pivot holders 12 and the mounting and dismounting of the swinging portions 23 relative to the upper holder block 30 are quite simple. Further, the component parts of the multipurpose stationery tool are inexpensive to manufacture.

As described above, the multipurpose stationery tool of the present invention has the characteristics of simple structure and ease of manufacturing, accurately achieving the objects of the present invention.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A multipurpose stationery tool, comprising:
a base extending in a longitudinal direction, said base comprising a first end, a pair of pivot holders mounted at said first end and spaced in a transverse direction perpendicular to said longitudinal direction, a pair of first position-limiting portions respectively disposed in said pivot holders at one side, a pair of second position-limiting portions respectively disposed in said pivot holders at another side, and a second end extended in said longitudinal direction opposite to said first end;
a supporting unit adjustable in position relative to said base, said supporting unit comprising a pair of pivoting portions respectively pivotally connected to said pivot holders and a pair of swinging portions opposite to said pivoting portions, said supporting unit being adjustable relative to said base between an extended position where said supporting unit is stopped in place relative to said base by said first position-limiting portions and a received position where said supporting unit is stopped in place relative to said base by said second position-limiting portions; and
an upper holder block adjustable in position relative to said supporting unit, said upper holder block comprising a holder block base, a pair of extension rods bilaterally extended from one side of said holder block base, two pivotal couplings located at a bottom side of said holder block base and spaced in said transverse direction and respectively pivotally connected to said swinging portions of said supporting unit, and two stop portions respectively located at said pivotal couplings at one side and adapted for stopping against said swinging portions in said extended position.

2. The multipurpose stationery tool as claimed in claim 1, wherein said supporting unit further comprises a pair of support bars; said pivoting portions and said swinging portions of said supporting unit are respectively located at opposing ends of said support bars.

3. The multipurpose stationery tool as claimed in claim 1, wherein said base further comprises a top wall extended from said first end to said second end; each said pivot holder comprises two upright pivot support plates spaced in said transverse direction and a pivoting space defined between said two upright pivot support plates; said first position-limiting portions are plate-shaped components protruded from said top wall; said first position-limiting portions are respectively abutted to the respective said pivoting spaces in said pivot holders and respectively connected with said upright pivot support plates of said pivot holders; said second position-limiting portions are respectively located at two opposite lateral sides of said top wall and substantially disposed in parallel to said top wall; said pivoting portions of said supporting unit are spherical and rotatably and pivotally mounted in the respective said pivoting spaces.

4. The multipurpose stationery tool as claimed in claim 3, wherein said upright pivot support plates of said pivot holders of said base each comprise a pivot hole; said pivoting portions of said supporting unit are peripherally partially protruding in the respective said pivot holes in such a manner that said pivoting portions are rotatable in all directions relative to the respective said pivot holders.

5. The multipurpose stationery tool as claimed in claim 4, wherein said pivotal couplings of said upper holder block each comprise two side panels spaced in said transverse direction and a pivoting space defined between said two side panels; said stop portions are plate shaped members protruded from said holder block base; said stop portions are respectively abutted to the respective said pivoting spaces of said pivotal couplings at one side, and respectively connected with the respective said side panels; said swinging portions of said supporting unit are spherical and rotatably mounted in the respective said pivoting spaces of said pivotal couplings of said upper holder block.

6. The multipurpose stationery tool as claimed in claim 5, wherein said side panels of said pivotal couplings of said upper holder block each comprise a through hole; said swinging portions of said supporting unit are peripherally protruding in said through holes of said side panels of said pivotal couplings in such a manner that said swinging portions are rotatable in all directions relative to the respective said pivotal couplings.

7. The multipurpose stationery tool as claimed in claim 1, wherein said upper holder block further comprises a positioning plate extended from said holder block base opposite to said extension rods.

8. The multipurpose stationery tool as claimed in claim 1, wherein said base further comprises a top wall extended from said first end to said second end, and a recessed chamber defined in said top wall and extended from said second end toward said first end.
